(19) United States
(12) Patent Application Publication
(10) Pub. No.: US 2026/0326235 A1
(43) Pub. Date: Oct. 22, 2026

(54) GALVO SCANNER POSITION COMPENSATION BY FAST SCANNING MEANS

(71) Applicant: Orbotech Ltd., Yavne (IL)

(72) Inventor: Yair Ben-Shaul, Tel Mond (IL)

(21) Appl. No.: 19/183,114

(22) Filed: Apr. 18, 2025

(51) Int. Cl. B23K 26/082; B23K 26/06; G02B 26/10; G02F 1/33

(52) U.S. Cl. CPC B23K 26/082; B23K 26/0643; G02B 26/105; G02F 1/33

(57) ABSTRACT

The system includes a galvo mirror configured to move to a mirror surface to a target position where the mirror surface directs a laser beam onto a target area of a surface of a workpiece. A processor receives a position signal from an encoder as the mirror surface moves before settling at the target position, and generates a response signal based on the position signal to compensate for a varying position of where the laser beam would impact the surface of the workpiece as the mirror surface moves before settling at the target position. The response signal is transmitted to an acousto-optical deflector (AOD) to deflect the path of the laser beam before reaching the galvo mirror, thereby controlling the laser beam to impact the target area of the surface of the workpiece before the mirror surface settles at the target position.

### FIELD OF THE DISCLOSURE

This disclosure relates to semiconductor fabrication and inspection and, more particularly, to laser processing of a printed circuit board.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

In some fabrication processes, a laser beam is used to drill or etch features on a surface of a workpiece. Besides moving a stage supporting the workpiece to impact different areas on the surface of the workpiece, optical elements disposed in the path of the laser beam can reposition the laser beam within a small area for fine adjustments. For example, a galvo mirror can have a rotatable mirror surface that deflects the laser beam, where the location of the surface of the workpiece that is impacted by the laser beam depends on the rotational position of the mirror surface. However, galvo mirrors change positions in a sinusoidal oscillating manner that slowly decays until the mirror surface settles at a target position. Thus, waiting for the mirror surface to settle between each movement reduces throughput, while directing the laser beam onto an oscillating mirror surface (i.e., before settling) reduces accuracy, as the location where the laser beam impacts the surface of the workpiece varies.

Therefore, what is needed is an improved method for fast and accurate laser beam positioning.

### BRIEF SUMMARY OF THE DISCLOSURE

An embodiment of the present disclosure provides a system. The system may comprise a stage configured to support a workpiece. The system may further comprise a laser source configured to emit a laser beam. The system may further comprise a galvo mirror configured to direct the laser beam onto a surface of the workpiece. The galvo mirror may comprise a mirror surface, a motor configured to rotate the mirror surface relative to the laser beam to adjust where the laser beam is directed onto the surface of the workpiece, and an encoder configured to generate a position signal corresponding to a rotational position of the mirror surface. The system may further comprise an acousto-optical deflector (AOD) positioned in a path of the laser beam between the laser source and the galvo mirror. The system may further comprise a processor in electronic communication with the galvo mirror and the AOD. The processor may be configured to send instructions to the motor to move to the mirror surface to a target position where the mirror surface directs the laser beam onto a target area of the surface of the workpiece. The processor may be further configured to receive the position signal from the encoder as the motor moves the mirror surface before settling at the target position. The processor may be further configured to generate a response signal based on the position signal to compensate for a varying position of where the laser beam would impact the surface of the workpiece as the mirror surface moves before settling at the target position. The processor may be further configured to transmit the response signal to the AOD to deflect the path of the laser beam before reaching the galvo mirror, thereby controlling the laser beam to impact the target area of the surface of the workpiece before the mirror surface settles at the target position.

In some embodiments, the processor may be further configured to determine a real time position of the mirror surface based on the position signal. The processor may be further configured to generate the response signal based on the real time position of the mirror surface, such that the AOD deflects the laser beam to compensate for a difference between the real time position of the mirror surface and the target position.

In some embodiments, the processor may be further configured to determine a sequence of positions of the mirror surface based on the position signal. The processor may be further configured to estimate a next position of the mirror surface based on the sequence of positions of the mirror surface. The processor may be further configured to generate the response signal based on the next position of the mirror surface, such that the AOD deflects the laser beam to compensate for a difference between the next position of the mirror surface and the target position.

In some embodiments, the laser source may be configured to emit the laser beam according to a pulse frequency. The processor may be configured to generate the response signal based on the position signal and the pulse frequency, such that a pulse of the laser beam impacts the target area of the surface of the workpiece before the mirror surface settles at the target position.

In some embodiments, the mirror surface may oscillate relative to the target position before settling at the target position.

In some embodiments, the stage may be configured to move the workpiece relative to the laser beam along a first axis. The rotational position of the mirror surface may adjust the position where the laser beam impacts the surface of the workpiece along a second axis that is orthogonal to the first axis.

In some embodiments, the AOD may be configured to deflect the path of the laser beam along the second axis before reaching the galvo mirror based on the response signal.

In some embodiments, the AOD may comprise a first AOD configured to deflect the path of the laser beam along the first axis before reaching the galvo mirror based on a first part of the response signal. The AOD may further comprise a second AOD configured to deflect the path of the laser beam along the second axis before reaching the galvo mirror based on a second part of the response signal.

Another embodiment of the present disclosure provides a method. The method may comprise rotating a mirror surface of a galvo mirror to a target position where the mirror surface directs a laser beam from a laser source onto a target area of a surface of a workpiece. The method may further comprise generating, with an encoder, a position signal corresponding to a rotational position of the mirror surface as the mirror surface moves before settling at the target position. The method may further comprise generating, with a processor, a response signal based on the position signal to compensate for a varying position of where the laser beam would impact the surface of the workpiece as the mirror surface moves before settling at the target position. The method may further comprise transmitting, with the processor, the response signal to an acousto-optical deflector (AOD) positioned in a path of the laser beam between the laser source and the galvo mirror to deflect the path of the laser beam before reaching the galvo mirror, thereby controlling the laser beam to impact the target area of the surface of the workpiece before the mirror surface settles at the target position.

In some embodiments, generating, with the processor, the response signal based on the position signal to compensate for the varying position of where the laser beam would impact the surface of the workpiece as the mirror surface moves before settling at the target position may comprise: determining a real time position of the mirror surface based on the position signal; and generating the response signal based on the real time position of the mirror surface, such that the AOD deflects the laser beam to compensate for a difference between the real time position of the mirror surface and the target position.

In some embodiments, generating, with the processor, the response signal based on the position signal to compensate for the varying position of where the laser beam would impact the surface of the workpiece as the mirror surface moves before settling at the target position may comprises: determining a sequence of positions of the mirror surface based on the position signal; estimating a next position of the mirror surface based on the sequence of positions of the mirror surface; and generating the response signal based on the next position of the mirror surface, such that the AOD deflects the laser beam to compensate for a difference between the next position of the mirror surface and the target position.

In some embodiments, the method may further comprise emitting, with the laser source, the laser beam according to a pulse frequency. Generating, with the processor, the response signal based on the position signal to compensate for the varying position of where the laser beam would impact the surface of the workpiece as the mirror surface moves before settling at the target position may comprise generating the response signal based on the position signal and the pulse frequency, such that a pulse of the laser beam impacts the target area of the surface of the workpiece before the mirror surface settles at the target position.

In some embodiments, the mirror surface may oscillate relative to the target position before settling at the target position.

In some embodiments, the method may further comprise moving the workpiece relative to the laser source with a stage along a first axis. Rotating the mirror surface of the galvo mirror to the target position may adjust the position where the laser beam impacts the surface of the workpiece along a second axis that is orthogonal to the first axis.

In some embodiments, transmitting, with the processor, the response signal to the AOD to deflect the path of the laser beam before reaching the galvo mirror may comprise: transmitting a first part of the response signal to a first AOD configured to deflect the path of the laser beam along the first axis before reaching the galvo mirror based on the first part of the response signal; and transmitting a second part of the response signal to a second AOD configured to deflect the path of the laser beam along the second axis before reaching the galvo mirror based on the second part of the response signal.

### DESCRIPTION OF THE DRAWINGS

For a fuller understanding of the nature and objects of the disclosure, reference should be made to the following detailed description taken in conjunction with the accompanying drawings, in which:

FIG. 1A is a side view of a system according to an embodiment of the present disclosure;

FIG. 1B is a top view of the system of FIG. 1A;

FIG. 2 is another side view of the system of FIG. 1A, in which the acousto-optical deflector deflects the laser beam before reaching the mirror surface of the galvo mirror;

FIG. 3 is a side view of a system according to another embodiment of the present disclosure;

FIG. 4 is a flowchart of a method according to an embodiment of the present disclosure;

FIG. 5 is a flowchart of a method according to another embodiment of the present disclosure;

FIG. 6 is a flowchart of a method according to another embodiment of the present disclosure;

FIG. 7 is a flowchart of a method according to another embodiment of the present disclosure;

FIG. 8 is a flowchart of a method according to another embodiment of the present disclosure; and

FIG. 9 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

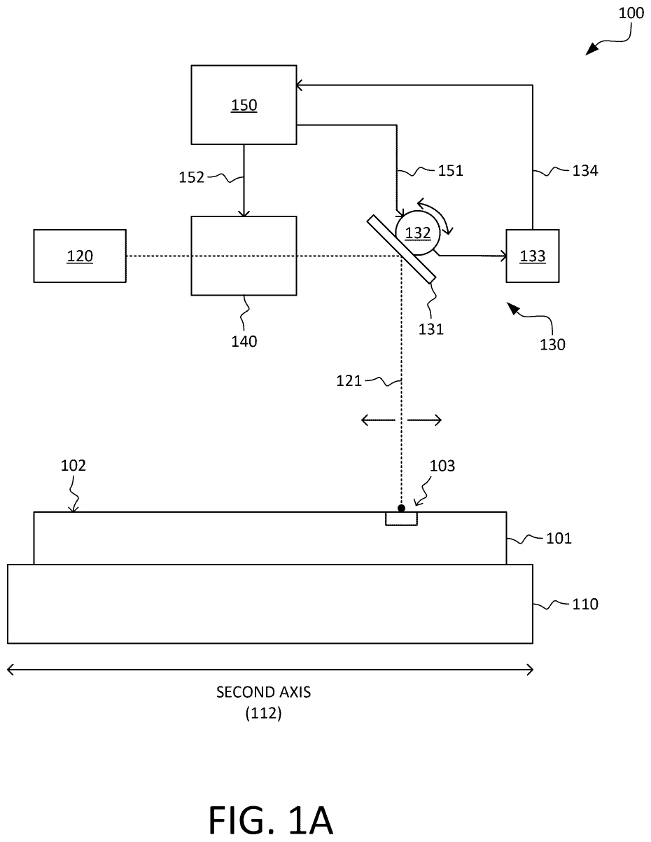

An embodiment of the present disclosure provides a system 100, as shown in FIGS. 1A and 1B. The system 100 may be configured to perform laser processing of a workpiece 101 (i.e., drilling, etching, etc.). The workpiece 101 may be, for example, a semiconductor wafer or substrate, such as a printed circuit board (PCB). The workpiece 101 may include a plurality of target areas 103 defined on a surface 102 of the workpiece 101. Each target area 103 may be a pad. A pad may be an exposed region of metal on the surface 102 of the workpiece 101 for connection to an electronic component. Drilling a hole in the workpiece 101 at the target area 103 may produce a through-hole pad. Although FIGS. 1A and 1B illustrate only one exemplary target area 103, any number of target areas 103 may be defined on the surface 102 of the workpiece 101.

The system 100 may comprise a stage 110. The stage 110 may be configured to support the workpiece 101. The stage 110 may include one or more motors or actuators configured to move the workpiece 101 supported by the stage 110. For example, the stage 110 may be configured to move the workpiece 101 in one or more in-plane directions, described as movements along a first axis 111 (i.e., x-direction) and a second axis 112 (i.e., y-direction) herein. The stage 110 may be further configured to move the workpiece 101 in one or more out-of-plane directions (i.e., z-direction).

The system 100 may further comprise a laser source 120. The laser source 120 may be configured to emit a laser beam 121. The laser beam 121 may have a beam diameter in the tens of micron range. The laser beam 121 may have a wavelength in the ultraviolet (UV) to far infra-red (IR) spectral range. In some embodiments, the laser source 120 may be configured to emit the laser beam 121 according to a pulse frequency, so as to periodically emit laser pulses. The pulse frequency may be, for example, in the microsecond range.

The system 100 may further comprise a galvo mirror 130. The galvo mirror 130 may be configured to direct the laser beam 121 onto the surface 102 of the workpiece 101. The galvo mirror 130 may comprise a mirror surface 131, a motor 132 configured to rotate the mirror surface 131 relative to the laser beam 121 to adjust where the laser beam 121 is directed onto the surface 102 of the workpiece 101, and an encoder 133 configured to generate a position signal 134 corresponding to a rotational position of the mirror surface 131. In some embodiments, the galvo mirror 130 may be a fast steering mirror (FSM) that uses voice coils or piezo motors to move the mirror surface 131. In some embodiments, the motor 132 may be configured to rotate the mirror surface 131 within a range of ±0.4 radians, depending on the specific type of motor used. The sampling frequency of the encoder 133 may be in the microsecond range. In some embodiments, the sampling frequency of the encoder 133 may be synchronized with the pulse frequency of the laser source 120, or their frequencies may be independent.

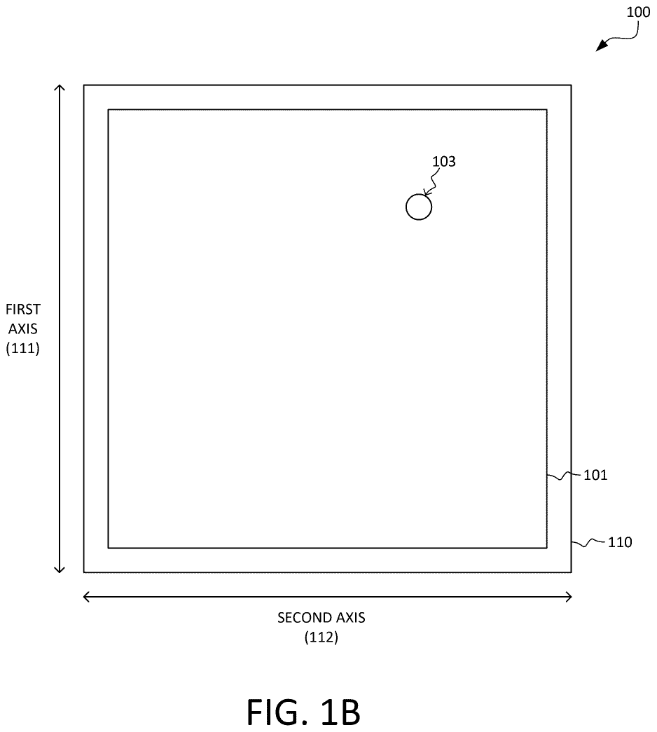

The system 100 may further comprise an acousto-optical deflector (AOD) 140 positioned in the path of the laser beam 121 between the laser source 120 and the galvo mirror 130. The AOD 140 may be configured to deflect the path of the laser beam 121 before reaching the galvo mirror 130. For example, the AOD 140 may be configured to enable the laser beam 121 to reach the mirror surface 131 unimpeded (as shown in FIG. 1A), block the laser beam 121 from reaching the mirror surface 131 (not shown), and/or adjust/correct the path of the laser beam 121 reaching the mirror surface 131 (as shown in FIG. 2) by deflecting the path of the laser beam 121. In some embodiments, the sampling frequency of the encoder 133 may be set dependent on the response time of the AOD 140. Using the stage 110 alone for laser steering may be slow and have low accuracy. Introducing the galvo mirror 130 may be 2 to 3 orders of magnitude faster to improve local performance, and further supplementing the AOD 140 may be another 2 to 3 orders of magnitude faster to further enhance laser steering performance, at the sacrifice of a smaller field of view.

The system 100 may further comprise a processor 150. The processor 150 may include a microprocessor, a microcontroller, or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 110. For example, the processor 150 may be configured to send instructions to the one or more motors or actuators of the stage 110 to move the workpiece 101 relative to the laser beam 121 along the first axis 111 or the second axis 112. The stage 110 may move the workpiece 101 such that the laser beam 121 is configured to be aligned with the target area 103 of the workpiece 101 (i.e., by further alignment with the galvo mirror 130 and/or the AOD 140, as further described below). In some embodiments, the stage 110 may move at a constant velocity through laser processing, with the galvo mirror 130 and the AOD 140 being used to control positioning of the laser beam 121 to impact each target area 103 on the surface 102 of the workpiece 101 as the stage 110 scans the workpiece 101 relative to the laser beam 121.

The processor 150 may be in electronic communication with the laser source 120. For example, the processor 150 may be configured to send instructions to the laser source 120 to emit the laser beam 121 or stop emitting the laser beam 121. In some embodiments, the instructions sent to the laser source 120 may include a pulse frequency, such that the laser source emits the laser beam 121 according to the pulse frequency set by the processor 150.

The processor 150 may be in electronic communication with the galvo mirror 130. For example, the processor 150 may be configured to send instructions 151 to the motor 132 to move the mirror surface 131 to a target position where the mirror surface 131 directs the laser beam onto the target area 103 of the workpiece 101. The mirror surface 131 may oscillate relative to the target position before settling at the target position. For example, the mirror surface 131 may oscillate up to 100 microradians relative to the target position before settling at the target position. The processor 150 may be further configured to receive the position signal 134 from the encoder 133 as the motor 132 moves the mirror surface 131 before settling at the target position. The processor 150 may be further configured to generate a response signal 152 based on the position signal 134 to compensate for the varying position of where the laser beam 121 would impact the surface 102 of the workpiece 101 as the mirror surface 131 moves before settling at the target position. The compensation distance may depend on the lens. For example, for a lens with an effective focal length of 50 mm, 100 milliradian adjustment of the AOD 104 can be translated to 10 microns of movement of the laser beam 121.

The processor 150 may be in electronic communication with the AOD 140. For example, the processor 150 may be configured to transmit the response signal 152 to the AOD 140 to deflect the path of the laser beam 121 before reaching the galvo mirror 130. The frequency of the response signal 152 may control the angle of deflection of the AOD 140, which, in turn, controls the distance deflected by the laser beam 121. Accordingly, the AOD 140 can control the laser beam 121 to impact the target area 103 of the surface 102 of the workpiece 101 before the mirror surface 131 settles at the target position. In some embodiments, the movement of the stage 110 can adjust for the position of the laser beam 121 relative to the first axis 111, while the movement of the mirror surface 131 can adjust for the position of the laser beam 121 relative to the second axis 112. Accordingly, the processor 150 can account for a combination of movements of the stage 110 to position the workpiece 101 and movements of the galvo mirror 130 to position the mirror surface 131 such that the laser beam 121 impacts the target area 103 of the workpiece 101.

In some embodiments, the processor 150 may be configured to determine a real time position of the mirror surface 131 based on the position signal 134. The processor 150 may be configured to generate the response signal 152 based on the real time position of the mirror surface 131, such that the AOD 140 is configured to enable the laser beam 121 to reach the mirror surface 131 when the real time position of the mirror surface 131 is equal to the target position (as shown in FIG. 1A), and the AOD 140 is configured to deflect the laser beam 121 to compensate for a difference between the real time position of the mirror surface 131 and the target position (as shown in FIG. 2). Accordingly, the processor 150 defines the response signal 152 based on the real time position of the mirror surface 131, such that the laser beam 121 impacts the target area 103 of the workpiece 101 while the mirror surface 131 is still oscillating, before settling at the target position.

In some embodiments, the processor 150 may be configured to determine a sequence of positions of the mirror surface 131 based on the position signal 134 and estimate a next position of the mirror surface 131 based on the sequence of positions of the mirror surface 131. For example, the processor 150 may use curve fitting to define the movement of the mirror surface 131 based on the sequence of positions from the position signal 134 and the processor 150 can extrapolate the next position of the mirror surface 131 from the curve. Accordingly, the processor 150 can learn the movement behavior of the galvo mirror 130 for different velocity and acceleration/deceleration scenarios. The processor 150 may be further configured to generate the response signal 152 based on the next position of the mirror surface 131, such that the AOD 140 is configured to enable the laser beam 121 to reach the mirror surface 131 when the next position of the mirror surface 131 is equal to the target position (as shown in FIG. 1A), and the AOD 140 is configured to deflect the laser beam 121 to compensate for a difference between the next position of the mirror surface 131 and the target position (as shown in FIG. 2). Accordingly, the processor 150 defines the response signal 152 based on the extrapolated movement of the mirror surface 131, such that the laser beam 121 impacts the target area 103 of the workpiece 101 while the mirror surface 131 is still oscillating, before settling at the target position. By learning/predicting the movement of the mirror surface 131, control of the laser beam 121 can be improved, despite possible delays in communication with the processor 150 that would otherwise impact real time adjustments.

In some embodiments, the processor 150 may be configured to generate the response signal 152 based on the position signal 134 and the pulse frequency of the laser source 120, such that a pulse of the laser beam 121 impacts the target area 103 of the surface 102 of the workpiece 101 before the mirror surface 131 settles at the target position. This may allow the speed of the galvo mirror 130 to increase, while maintaining accuracy with the AOD 140, independent of the scanning speed of the stage 110. The processor 150 may repeat the steps provided above for each laser pulse.

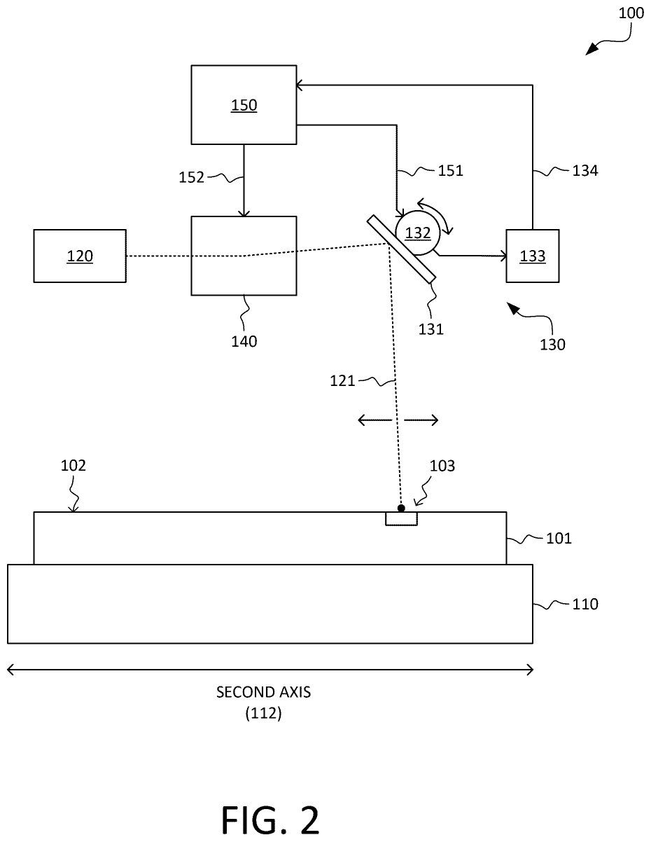

In some embodiments, the AOD 140 may comprise a first AOD 141 and a second AOD 142, as shown in FIG. 3. The first AOD 141 may be configured to deflect the path of the laser beam 121 along the first axis 111 (i.e., into/out of the page), and the second AOD 142 may be configured to deflect the path of the laser beam 121 along the second axis 112. The response signal 152 generated by the processor 150 may include a first part 152a transmitted to the first AOD 141 and a second part 152b transmitted to the second AOD 142. Accordingly, the processor 150 can define the response signal 152 to compensate for the varying position of where the laser beam 121 would impact the surface 102 of the workpiece 101 as the mirror surface 131 moves before settling at the target position along the first axis 111 and/or the second axis 112 according to the first part 152a and the second part 152b transmitted to the first AOD 141 and the second AOD 142, respectively.

With the system 100, the encoder 133 can provide real-time feedback of the rotational position of the mirror surface 131, such that the AOD 140 can be used to deflect the laser beam 121 to impact the target area 103 of the workpiece 101 before the mirror surface 131 settles at the target position. The combination of fast response time (μsec) and short laser pulses (μsec) can increase throughput, as waiting for the mirror surface 131 to settle can be avoided, and also increase accuracy, as the laser beam 121 is controlled to impact the target area 103 either through use of the AOD 140 as a shutter or to compensate for the varying position of the mirror surface 131.

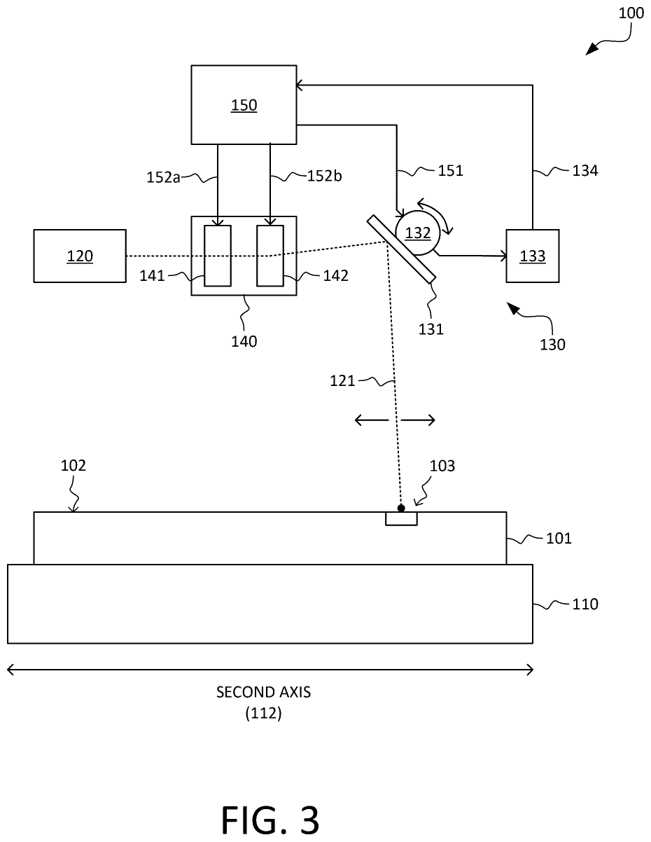

Another embodiment of the present disclosure provides a method 200. As shown in FIG. 4, the method 200 may comprise the following steps.

At step 210, a mirror surface of a galvo mirror is rotated to a target position where the mirror surface directs a laser beam from a laser source onto a target area of a surface of a workpiece.

At step 220, an encoder generates a position signal corresponding to a rotational position of the mirror surface as the mirror surface moves before settling at the target position.

At step 230, a processor generates a response signal based on the position signal to compensate for a varying position of where the laser beam would impact the surface of the workpiece as the mirror surface moves before settling at the target position.

At step 240, the processor transmits the response signal to an acousto-optical deflector (AOD) positioned in a path of the laser beam between the laser source and the galvo mirror to deflect the path of the laser beam before reaching the galvo mirror, thereby controlling the laser beam to impact the target area of the surface of the workpiece before the mirror surface settles at the target position.

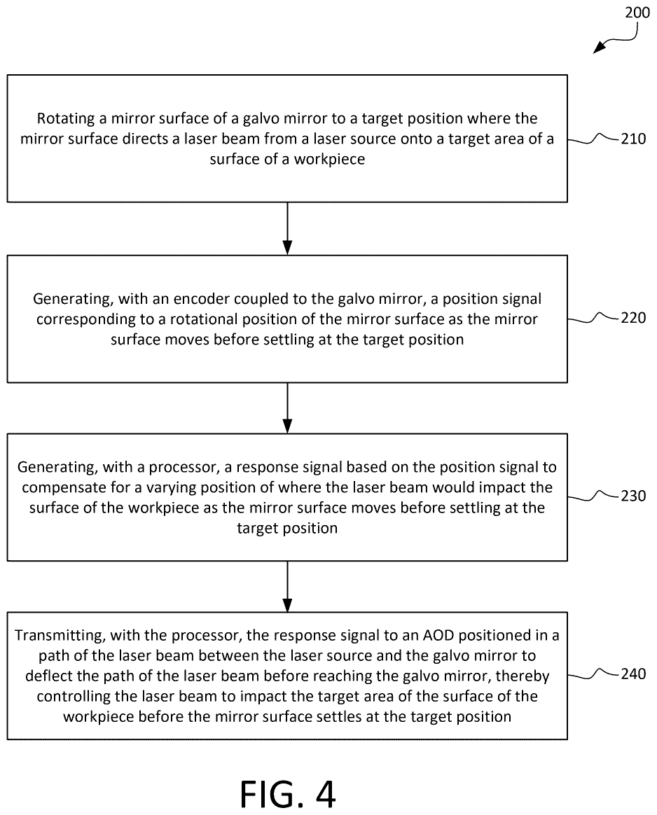

In some embodiments, step 230 may comprise the following steps shown in FIG. 5. At step 231, a real time position of the mirror surface is determined based on the position signal. At step 232, the response signal is generated based on the real time position of the mirror surface, such that the AOD deflects the laser beam to compensate for a difference between the real time position of the mirror surface and the target position. Accordingly, the AOD may correct the path of the laser beam, where the response signal controls the deflection of the laser beam before reaching the mirror surface so that the real time position of the mirror surface causes the laser beam to impact the target area of the surface of the workpiece before the mirror surface settles at the target position.

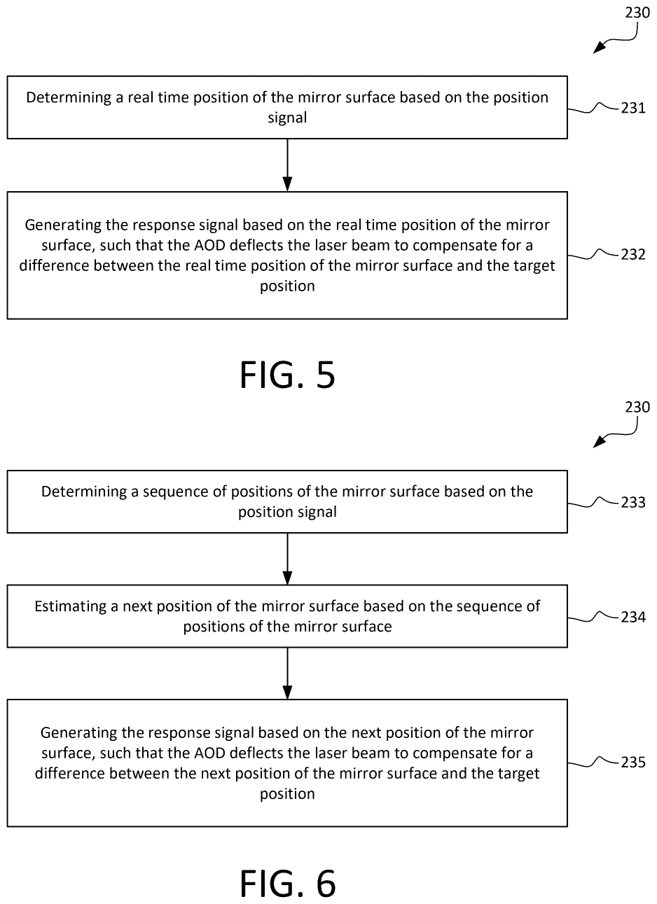

In some embodiments, step 230 may comprise the following steps shown in FIG. 6. At step 233, a sequence of positions of the mirror surface are determined based on the position signal. At step 234, a next position of the mirror surface is estimated based on the sequence of mirror positions. At step 235, the response signal is generated based on the next position of the mirror surface, such that the AOD deflects the laser beam to compensate for a difference between the next position of the mirror surface and the target position. Accordingly, the AOD may correct the path of the laser beam, where the response signal controls the deflection of the laser beam before reaching the mirror surface so that the anticipated next position of the mirror surface causes the laser beam to impact the target area of the surface of the workpiece before the mirror surface settles at the target position.

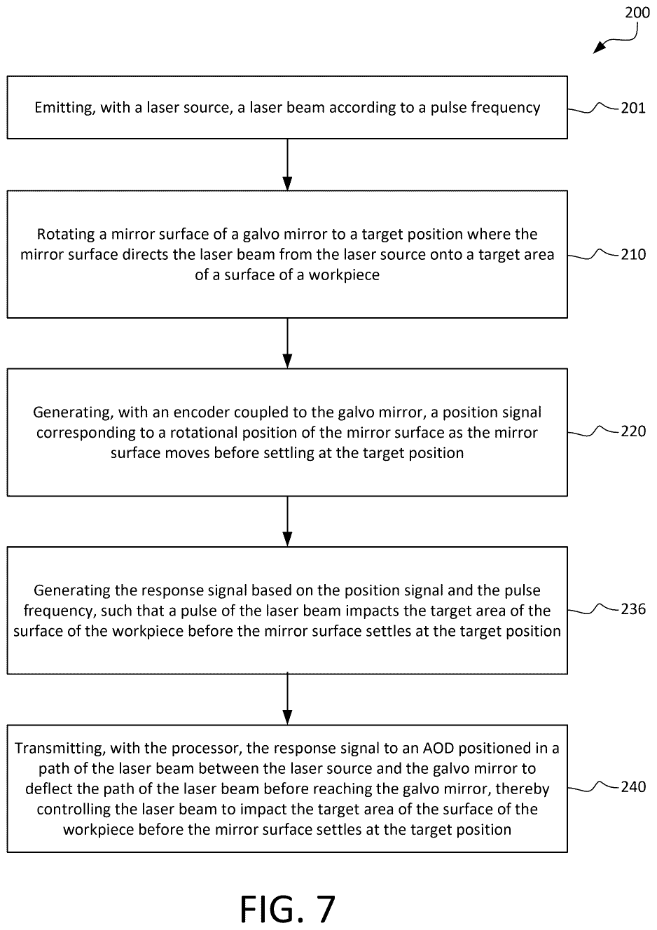

In some embodiments, the method 200 may further comprise step 201, as shown in FIG. 7. At step 201, a laser source emits a laser beam according to a pulse frequency. In this embodiment, step 230 may comprise step 236. At step 236, the response signal is generated based on the position signal and the pulse frequency, such that a pulse of the laser beam impacts the target area of the surface of the workpiece before the mirror surface settles at the target position. Accordingly, the operation of AOD may synchronize with the pulse frequency to open/close the shutter or correct the path of the laser beam based on the timing of the laser pulses.

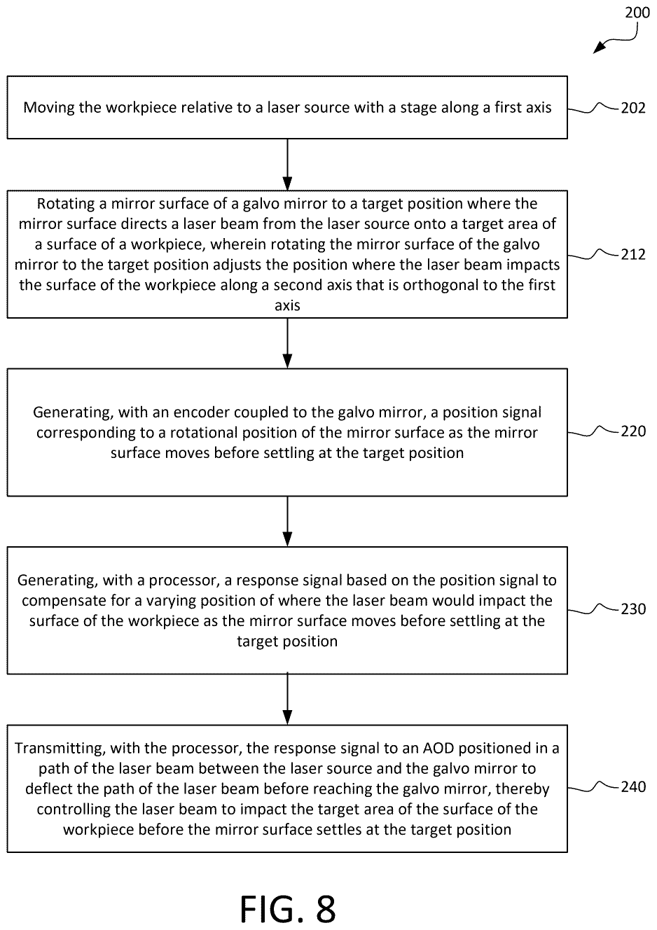

In some embodiments, the method may further comprise step 202, as shown in FIG. 8. At step 202, the workpiece is moved relative to the laser source with a stage along a first axis. In this embodiment, step 210 may comprise step 212. At step 212, a mirror surface of a galvo mirror is rotated to a target position where the mirror surface directs a laser beam from the laser source onto a target area of a surface of a workpiece, wherein rotating the mirror surface of the galvo mirror to the target position adjusts the position where the laser beam impacts the surface of the workpiece along a second axis that is orthogonal to the first axis. Accordingly, the adjustment of the rotational position of the mirror surface and the position of the stage can position the workpiece relative to the first axis and the second axis such that the laser beam impacts the target area of the workpiece.

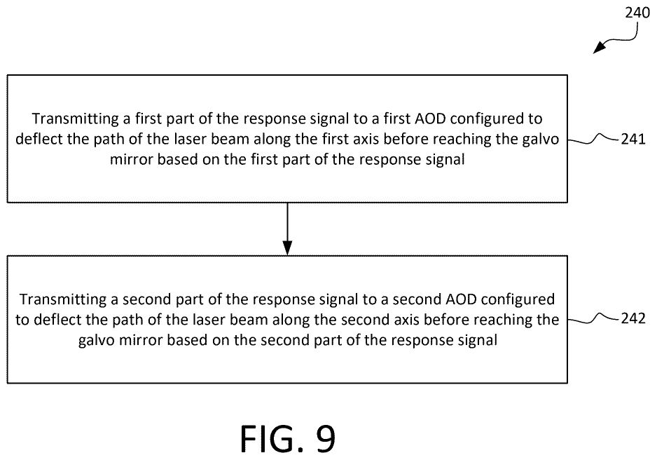

In some embodiments, step 240 may comprise the following steps shown in FIG. 9. At step 241, a first part of the response signal is transmitted to a first AOD configured to deflect the path of the laser beam along the first axis before reaching the galvo mirror based on the first part of the response signal. At step 242, a second part of the response signal is transmitted to a second AOD configured to deflect the path of the laser beam along the second axis before reaching the galvo mirror based on the second part of the response signal. Accordingly, the two AODs can correct the path of the laser beam relative to the first axis and the second axis before reaching the mirror surface to cause the laser beam to impact the target area of the surface of the workpiece before the mirror surface settles at the target position and without further movement of the stage.

While the optional steps of the method 200 are shown separately in connection with FIGS. 7-9, it should be understood that some embodiments may include each of the steps shown in these figures or any combination thereof.

With the method 200, the encoder can provide real-time feedback of the rotational position of the mirror surface, such that the AOD can be used to deflect the laser beam to impact the target area of the workpiece before the mirror surface settles at the target position. The combination of fast response time (μsec) and short laser pulses (μsec) can increase throughput, as waiting for the mirror surface to settle can be avoided, and also increase accuracy, as the laser beam is controlled to impact the target area either through use of the AOD as a shutter or to compensate for the varying position of the mirror surface.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a stage configured to support a workpiece;
a laser source configured to emit a laser beam;
a galvo mirror configured to direct the laser beam onto a surface of the workpiece, wherein the galvo mirror comprises a mirror surface, a motor configured to rotate the mirror surface relative to the laser beam to adjust where the laser beam is directed onto the surface of the workpiece, and an encoder configured to generate a position signal corresponding to a rotational position of the mirror surface;
an acousto-optical deflector (AOD) positioned in a path of the laser beam between the laser source and the galvo mirror; and
a processor in electronic communication with the galvo mirror and the AOD, wherein the processor is configured to:
send instructions to the motor to move to the mirror surface to a target position where the mirror surface directs the laser beam onto a target area of the surface of the workpiece;
receive the position signal from the encoder as the motor moves the mirror surface before settling at the target position;
generate a response signal based on the position signal to compensate for a varying position of where the laser beam would impact the surface of the workpiece as the mirror surface moves before settling at the target position; and
transmit the response signal to the AOD to deflect the path of the laser beam before reaching the galvo mirror, thereby controlling the laser beam to impact the target area of the surface of the workpiece before the mirror surface settles at the target position.

2. The system of claim 1, wherein the processor is further configured to:
determine a real time position of the mirror surface based on the position signal; and
generate the response signal based on the real time position of the mirror surface, such that the AOD deflects the laser beam to compensate for a difference between the real time position of the mirror surface and the target position.

3. The system of claim 1, wherein the processor is further configured to:
determine a sequence of positions of the mirror surface based on the position signal;
estimate a next position of the mirror surface based on the sequence of positions of the mirror surface; and
generate the response signal based on the next position of the mirror surface, such that the AOD deflects the laser beam to compensate for a difference between the next position of the mirror surface and the target position.

4. The system of claim 1, wherein the laser source is configured to emit the laser beam according to a pulse frequency, and the processor is configured to generate the response signal based on the position signal and the pulse frequency, such that a pulse of the laser beam impacts the target area of the surface of the workpiece before the mirror surface settles at the target position.

5. The system of claim 1, wherein the mirror surface oscillates relative to the target position before settling at the target position.

6. The system of claim 1, wherein the stage is configured to move the workpiece relative to the laser beam along a first axis, and the rotational position of the mirror surface adjusts the position where the laser beam impacts the surface of the workpiece along a second axis that is orthogonal to the first axis.

7. The system of claim 6, wherein the AOD is configured to deflect the path of the laser beam along the second axis before reaching the galvo mirror based on the response signal.

8. The system of claim 6, wherein the AOD comprises:
a first AOD configured to deflect the path of the laser beam along the first axis before reaching the galvo mirror based on a first part of the response signal; and
a second AOD configured to deflect the path of the laser beam along the second axis before reaching the galvo mirror based on a second part of the response signal.

9. A method comprising:
rotating a mirror surface of a galvo mirror to a target position where the mirror surface directs a laser beam from a laser source onto a target area of a surface of a workpiece;
generating, with an encoder, a position signal corresponding to a rotational position of the mirror surface as the mirror surface moves before settling at the target position;
generating, with a processor, a response signal based on the position signal to compensate for a varying position of where the laser beam would impact the surface of the workpiece as the mirror surface moves before settling at the target position; and
transmitting, with the processor, the response signal to an acousto-optical deflector (AOD) positioned in a path of the laser beam between the laser source and the galvo mirror to deflect the path of the laser beam before reaching the galvo mirror, thereby controlling the laser beam to impact the target area of the surface of the workpiece before the mirror surface settles at the target position.

10. The method of claim 9, wherein generating, with the processor, the response signal based on the position signal to compensate for the varying position of where the laser beam would impact the surface of the workpiece as the mirror surface moves before settling at the target position comprises:
determining a real time position of the mirror surface based on the position signal; and
generating the response signal based on the real time position of the mirror surface, such that the AOD deflects the laser beam to compensate for a difference between the real time position of the mirror surface and the target position.

11. The method of claim 9, wherein generating, with the processor, the response signal based on the position signal to compensate for the varying position of where the laser beam would impact the surface of the workpiece as the mirror surface moves before settling at the target position comprises:
determining a sequence of positions of the mirror surface based on the position signal;
estimating a next position of the mirror surface based on the sequence of positions of the mirror surface; and
generating the response signal based on the next position of the mirror surface, such that the AOD deflects the laser beam to compensate for a difference between the next position of the mirror surface and the target position.

12. The method of claim 9, further comprising:
emitting, with the laser source, the laser beam according to a pulse frequency; and
wherein generating, with the processor, the response signal based on the position signal to compensate for the varying position of where the laser beam would impact the surface of the workpiece as the mirror surface moves before settling at the target position comprises:
generating the response signal based on the position signal and the pulse frequency, such that a pulse of the laser beam impacts the target area of the surface of the workpiece before the mirror surface settles at the target position.

13. The method of claim 9, wherein the mirror surface oscillates relative to the target position before settling at the target position.

14. The method of claim 9, further comprising:
moving the workpiece relative to the laser source with a stage along a first axis;
wherein rotating the mirror surface of the galvo mirror to the target position adjusts the position where the laser beam impacts the surface of the workpiece along a second axis that is orthogonal to the first axis.

15. The method of claim 14, wherein transmitting, with the processor, the response signal to the AOD to deflect the path of the laser beam before reaching the galvo mirror comprises:
transmitting a first part of the response signal to a first AOD configured to deflect the path of the laser beam along the first axis before reaching the galvo mirror based on the first part of the response signal; and
transmitting a second part of the response signal to a second AOD configured to deflect the path of the laser beam along the second axis before reaching the galvo mirror based on the second part of the response signal.
